(19) United States
(12) Patent Application Publication
(10) Pub. No.: US 2024/0310701 A1
(43) Pub. Date: Sep. 19, 2024

(54) Projection lens module and projection device

(71) Applicant: Coretronic Corporation, Hsin-Chu (TW)

(72) Inventors: YI-CHANG CHEN, Hsin-Chu (TW); SHENG-YU CHIU, Hsin-Chu (TW)

(21) Appl. No.: 18/605,849

(22) Filed: Mar. 15, 2024

(30) Foreign Application Priority Data
Mar. 17, 2023 (CN) 202310258324.4

(51) Int. Cl. G03B 21/14; G03B 21/20

(52) U.S. Cl. CPC G03B 21/142; G03B 21/208

(57) ABSTRACT

A projection lens module includes a projection lens and an adjustment device connected to the projection lens and adjusting a movement of the projection lens. The adjustment device includes a turntable, a combination plate, and an assembly member. The combination plate has an elastic member having a first combination unit. The assembly member includes a contact plate and a screw rod connecting the first surface of the contact plate. The second surface of the contact plate has a second combination unit clamped to the first combination unit. When the turntable rotates, the first combination unit drives the second combination unit to rotate around the axis. When the turntable maintains rotation and the assembly member is fixed, the elastic member generates elastic deformation, and therefore the first and second combination units are separated from each other so that the combination plate and the assembly member rotate relatively.

### CROSS-REFERENCE TO RELATED APPLICATION

This application claims the priority benefit of the China application (No. 202310258324.4), filed on Mar. 17, 2023. The entirety of the above-mentioned patent application is hereby incorporated by reference herein and made a part of this specification.

### TECHNICAL FIELD

The present disclosure relates to a projection lens module and a projection device, and more particularly to a projection lens module and a projection device capable of adjusting the position of a projection lens.

### BACKGROUND

A projector is a device that allows the illumination beam generated by an internal light source to pass through a light valve to form an image beam, and then projects the image beam onto the screen through a projection lens to form an image. In order to improve the clarity of the image, in addition to the need for adequate resolution in the light valve, the relationship of the position and angle between the projection lens projecting the image beam onto the screen and the screen must also be accurate.

In order to adjust the projection position and angle of the image beam, the conventional adjustment method is to adjust the placement position and angle of the entire machine to adjust the projected image beam. Specifically, in the conventional adjustment method, a plurality of adjustable screws are arranged at the bottom of the projector, and then the distance between the grounding point and the projector casing is adjusted to adjust the upper and lower positions and projection angles, and then the placement position is adjusted to adjust the left and right positions and projection angles.

The information disclosed in this “BACKGROUND” section is only for enhancement understanding of the background of the disclosure and therefore it may contain information that does not form the prior art that is already known to a person of ordinary skill in the art. Furthermore, the information disclosed in this “BACKGROUND” section does not mean that one or more problems to be solved by one or more embodiments of the disclosure were acknowledged by a person of ordinary skill in the art.

### SUMMARY

An embodiment of the present disclosure provides a projection lens module, which includes a projection lens and an adjustment device. The projection lens is configured to project an image beam. The adjustment device is connected to the projection lens and configured to adjust a movement of the projection lens. The adjustment device includes a turntable, a combination plate, and an assembly member. The turntable is configured to rotate around an axis. The combination plate is fixed to the turntable and has an elastic member. The elastic member has at least one first combination unit. The assembly member includes a contact plate and a screw rod. The contact plate has a first surface and a second surface opposite to the first surface. The screw rod connects the first surface of the contact plate. The second surface of the contact plate has at least one second combination unit. The second combination unit is clamped to the respective first combination unit. When the turntable rotates, the first combination unit of the combination plate is configured to drive the respective second combination unit of the assembly member to rotate around the axis. When the turntable maintains rotation and the assembly member is fixed, the elastic member is configured to generate elastic deformation by pushing between the first combination unit and the second combination unit, and therefore the first combination unit and the second combination unit are separated from each other so that the combination plate and the assembly member rotate relatively.

An embodiment of the present disclosure provides a projection device, which includes a light source, a light valve, and a projection lens module. The light source is configured to provide an illumination beam. The light valve is configured to convert the illumination beam into an image beam. The projection lens module is configured to adjust a position of the image beam projected by the projection device. The projection lens module includes a projection lens and an adjustment device. The projection lens is configured to project the image beam. The adjustment device is connected to the projection lens and configured to adjust a movement of the projection lens. The adjustment device includes a turntable, a combination plate, and an assembly member. The turntable is configured to rotate around an axis. The combination plate is fixed to the turntable and has an elastic member. The elastic member has at least one first combination unit. The assembly member includes a contact plate and a screw rod. The contact plate has a first surface and a second surface opposite to the first surface. The screw rod connects the first surface of the contact plate. The second surface of the contact plate has at least one second combination unit. The second combination unit is clamped to the respective first combination unit. When the turntable rotates, the first combination unit of the combination plate is configured to drive the respective second combination unit of the assembly member to rotate around the axis. When the turntable maintains rotation and the assembly member is fixed, the elastic member is configured to generate elastic deformation by pushing between the first combination unit and the second combination unit, and therefore the first combination unit and the second combination unit are separated from each other so that the combination plate and the assembly member rotate relatively.

Other objectives, features and advantages of the disclosure will be further understood from the further technological features disclosed by the embodiments of the disclosure wherein there are shown and described preferred embodiments of the present disclosure, simply by way of illustration of modes best suited to carry out the disclosure.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a block diagram of a projection device according to an embodiment of the present disclosure;

FIG. 2A is a schematic exploded diagram of a projection lens module according to an embodiment of the present disclosure;

FIG. 2B is a schematic enlarged diagram of a local part of the projection lens module of FIG. 2A;

FIG. 3A is a schematic exploded diagram of an adjustment device in FIG. 2A;

FIG. 3B is a schematic cross-sectional diagram of the adjustment device in FIG. 2A when the screw rod can still rotate;

FIG. 3C is a schematic cross-sectional diagram of the adjustment device in FIG. 2A when the screw rod cannot rotate;

FIG. 4A is a schematic top diagram of the adjustment device in the state shown in FIG. 3B;

FIG. 4B is a schematic top diagram of the adjustment device in the state shown in FIG. 3C; and

FIG. 5 is a schematic top diagram of a combination plate in another embodiment of the present disclosure.

### DETAILED DESCRIPTION OF PREFERRED EMBODIMENTS

In the following detailed description of the preferred embodiments, reference is made to the accompanying drawings which form a part hereof, and in which is shown by way of illustration specific embodiments in which the disclosure may be practiced. In this regard, directional terminology, such as “top”, “bottom”, “front”, “back”, etc., is used with reference to the orientation of the Figure(s) being described. The components of the disclosure can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the disclosure. Also, it is to be understood that the phraseology and terminology used herein are for the purpose of description and should not be regarded as limiting. The use of “including”, “comprising”, or “having” and variations thereof herein is meant to encompass the items listed thereafter and equivalents thereof as well as additional items. Unless limited otherwise, the terms “connected”, “coupled”, and “mounted” and variations thereof herein are used broadly and encompass direct and indirect connections, couplings, and mountings. Similarly, the terms “facing”, “faces”, and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

The present disclosure provides a projection lens module and a projection device with an adjustment device that can drive the movement of the projection lens. Specifically, when the projection lens is driven to the limit position of the adjustable range by the adjustment device, the adjustment device will automatically disconnect to prevent excessive movement of the projection lens.

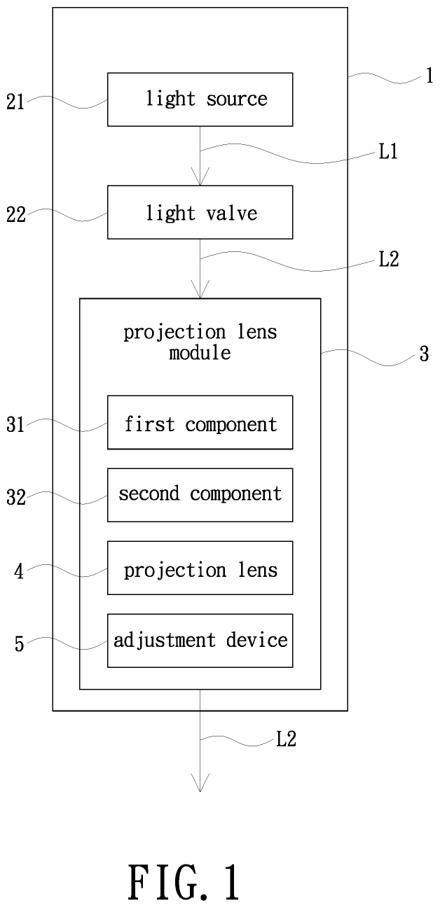

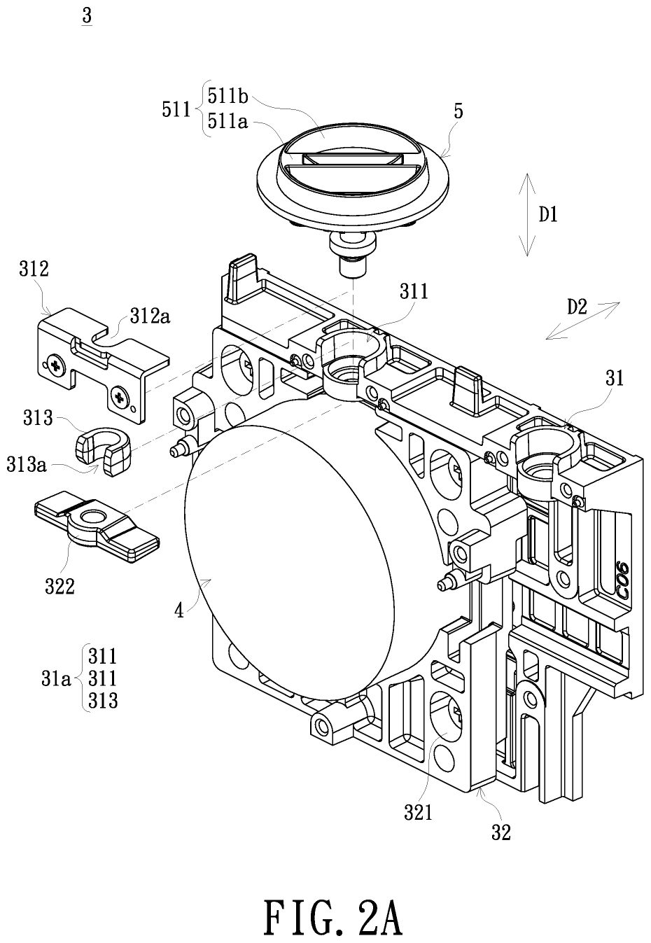

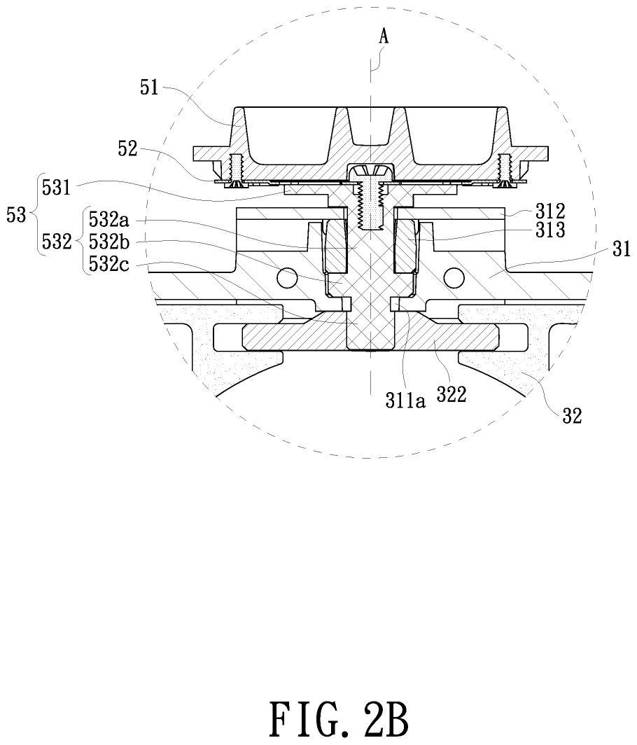

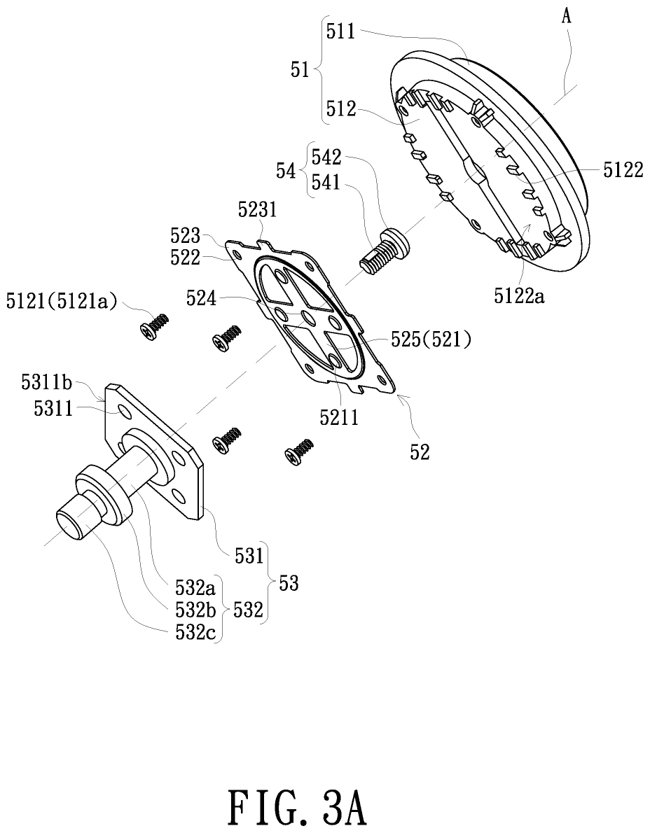

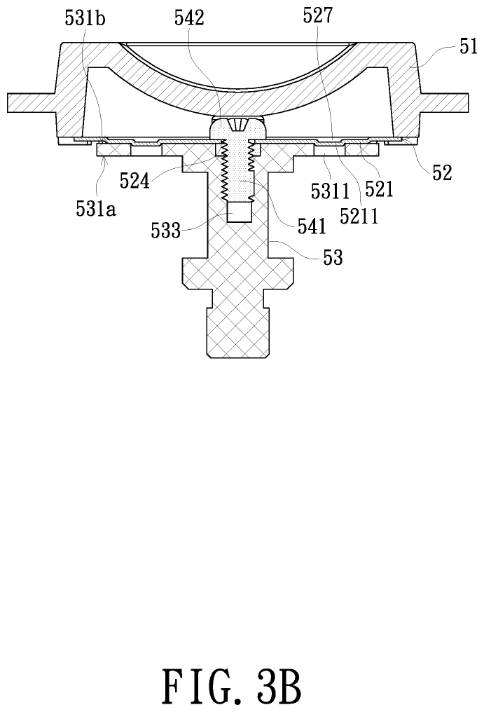

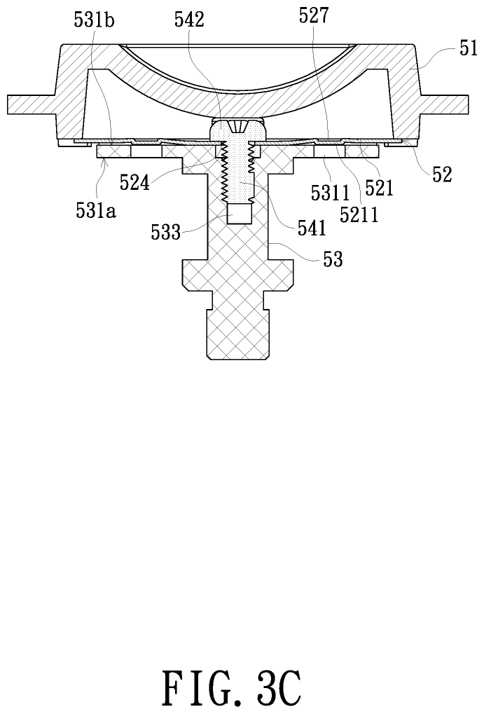

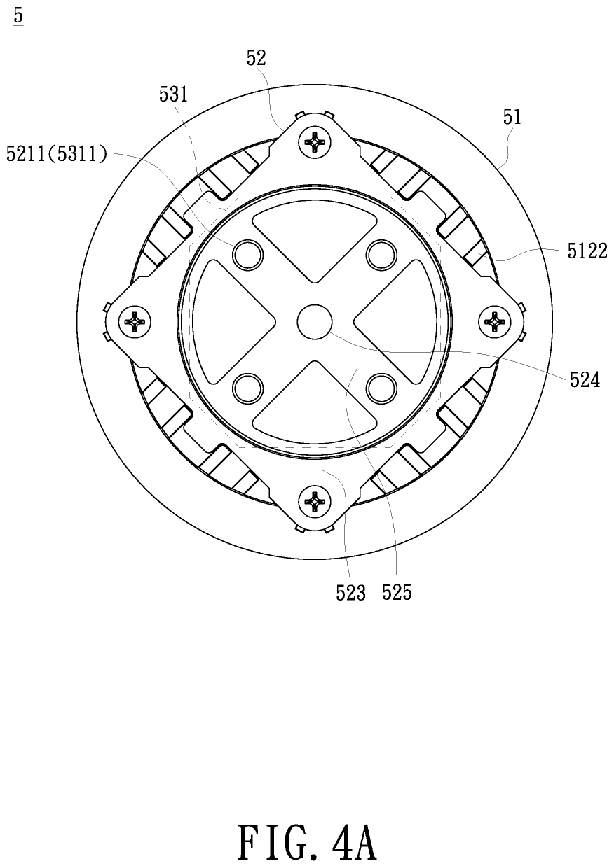

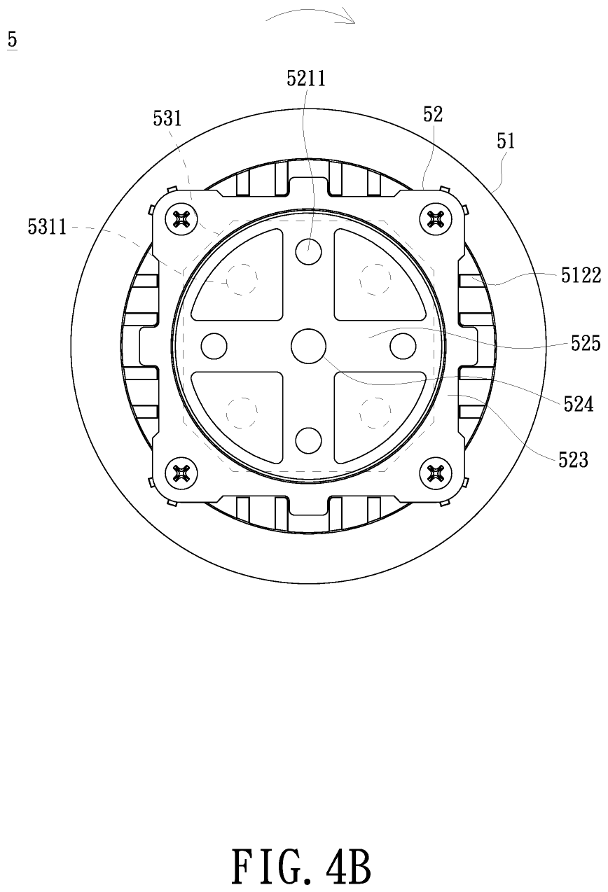

FIG. 1 is a block diagram of a projection device according to an embodiment of the present disclosure. FIG. 2A is a schematic exploded diagram of a projection lens module according to an embodiment of the present disclosure. FIG. 2B is a schematic enlarged diagram of a local part of the projection lens module of FIG. 2A. FIG. 3A is a schematic exploded diagram of an adjustment device in FIG. 2A. FIG. 3B is a schematic cross-sectional diagram of the adjustment device in FIG. 2A when the screw rod can still rotate. FIG. 3C is a schematic cross-sectional diagram of the adjustment device in FIG. 2A when the screw rod cannot rotate. FIG. 4A is a schematic top diagram of the adjustment device in the state shown in FIG. 3B. FIG. 4B is a schematic top diagram of the adjustment device in the state shown in FIG. 3C.

As shown in FIG. 1, the projection device 1 includes a light source 21, a light valve 22, and a projection lens module 3. The light source 21 is configured to provide an illumination beam L1. The light source 21 can be light bulbs, light-emitting diodes (LEDs), laser diodes (LDs), etc., but not limited thereto. The light valve 22 is configured to convert the illumination beam L1 into an image beam L2. The light valve 22 can be a transmissive light valve (e.g., liquid crystal panel) or a reflective light valve (e.g., digital micro-mirror device (DMD) or a liquid crystal on silicon (LCOS) panel), but is not limited thereto. The projection lens module 3 is configured to project the image beam L2 generated by the light valve 22 onto a screen or a wall (not shown in the figure) to form an image on the screen or wall.

In this embodiment, the projection lens module 3 includes a projection lens 4 and an adjustment device 5. The projection lens 4 is configured to project the image beam L2. The adjustment device 5 is connected to the projection lens 4 (see FIG. 2) and is configured to adjust the movement of the projection lens 4. As shown in FIGS. 2A to 3A, the adjustment device 5 includes a turntable 51, a combination plate 52, and an assembly member 53. The turntable 51 is configured to rotate around an axis A. The combination plate 52 is fixed to the turntable 51 and has an elastic member 521. The elastic member 521 has at least one first combination unit 5211. The assembly member 53 includes a contact plate 531 and a screw rod 532. The screw rod 532 is connected to the first surface 531a of the contact plate 531. The second surface 531b of the contact plate 531 has at least one second combination unit 5311. The second combination unit 5311 is clamped to the respective first combination unit 5211. Therefore, as shown in FIGS. 3B and 4A, when the turntable 51 rotates, the first combination unit 5211 of the combination plate 52 is configured to drive the respective second combination unit 5311 of the assembly member 53 to rotate around the axis A. As shown in FIGS. 3C and 4B, when the turntable 51 maintains rotation and the assembly member 53 is fixed, the elastic member 521 generates elastic deformation by the pushing force between the first combination unit 5211 and the second combination unit 5311, so that the first combination unit 5211 and the second combination unit 5311 are separated from each other, and the combination plate 52 and the assembly member 53 rotate relatively.

As shown in FIG. 1, the projection lens module 3 in this embodiment further includes a first component 31 and a second component 32. The first component 31, the second component 32, the projection lens 4, and the adjustment device 5 of the projection lens module 3 only indicate that the projection lens module 3 includes the aforementioned components, not indicate the order in which the image beam L2 passes through the components. As shown in FIGS. 2A and 2B, the projection lens module 3 in this embodiment includes, for example, the first component 31 and the second component 32. The first component 31 is, for example, a lens carrier plate, and the second component 32 is, for example, a connecting plate, which is configured to connect the projection lens 4. The connecting plate as the second component 32 is provided with, for example, four sliding slots 321 extending along the direction D1 in FIG. 2A, and the connecting plate as the second component 32 can be slidingly connected to the first component 31 in the direction D1 through the four screws arranged in the sliding slots 321. The adjustment device 5 is mounted on the first component 31 in a rotating but not movable manner, and the extending direction of the rotation axis of the adjustment device 5 is the same as the direction D1. The screw rod 532 is screwed to the adjustment member 322 sleeved on the second component 32. Thus, the second component 32 can move in the direction D1 with the rotation of the screw rod 532 when the screw rod 532 rotates.

As shown in FIGS. 2A to 4B, the turntable 51 of the adjustment device 5 in this embodiment forms a gripping portion 511 on the surface of the turntable 51 away from the combination plate 52. The gripping portion 511 is suitable for the user's fingers to grip and formed in shape by, for example, through the convex rib 511a located in the center and the concave grooves 511b on the both sides of the convex rib 511a, and the concave groove 511b is circular in shape on the convex rib 511a. However, the shape of the turntable 51 is not limited in the present disclosure. For example, the turntable 51 in another embodiment can have a plurality of teeth (not shown in the figure) on its side surface, and other conventional mechanical components such as gears can drive the turntable 51 to rotate through the teeth.

As shown in FIG. 3A, the turntable 51 has a combination portion 512 on the side of the turntable 51 close to the combination plate 52, and the combination portion 512 is configured to connect with the combination plate 52. The combination portion 512 is, for example, a plurality of positioning columns 5121 each composed of a screw member 5121a (screws). Each of the positioning column 5121 is arranged to pass through the respective positioning hole 522 on the combination plate 52 and then is screwed into the screw hole (not shown in the figure) on the side surface of the turntable 51 facing the combination plate 52. Therefore, the combination plate 52 can be driven by the positioning columns 5121 of the turntable 51 to rotate with the turntable 51 when the turntable 51 is driven by the user's fingers to rotate around the axis A.

The fixing means between the combination plate 52 and the turntable 51 is not limited in the present disclosure. For example, in the embodiment where the turntable 51 is made of elastic materials such as plastic, the positioning column 5121 can be directly formed on the combination portion 512 and directly clamped into the respective positioning hole 522 through the elasticity of the elastic material. In another embodiment, a plurality of grooves (not shown in the figure) can be formed on the combination portion 512, and a plurality of protrusions (not shown in the figure) suitable for the insertion in the grooves can be formed by bending the side surface of the combination plate 52 close to the grooves 313a. Other fixing structures can be used for the fixing between the combination plate 52 and the turntable 51.

In addition, the turntable 51 in this embodiment also has a plurality of convex blocks 5122 on the side of the turntable 51 close to the combination plate 52. The convex blocks 5122 together form an accommodation groove 5122a located in the center of the turntable 51. The contour of the accommodation groove 5122a corresponds to the contour of the side surfaces of the combination plate 52; in other words, each side surface of the combination plate 52 can contact with the respective convex blocks 5122 when the combination plate 52 is assembled to the turntable 51. Therefore, when the turntable 51 of this embodiment rotates, the combination plate 52 can not only be driven by the positioning columns 5121, but also be driven to rotate with the convex blocks 5122 through the convex blocks 5122 pushing against the edges of the combination plate 52, thereby ensuring that the turntable 51 can apply sufficient force to drive the combination plate 52 to rotate and reduce the load on the positioning columns 5121. However, the detailed shape and structure of the accommodation groove 5122a are not limited in the present disclosure.

Please refer to FIGS. 2A to 4B. The combination plate 52 in this embodiment has, for example, an outer frame 523, four connecting arms 525, and a first central hole 524, wherein the first central hole 524 is located in the center of the combination plate 52. In other words, in this embodiment, the outer frame 523 surrounds the elastic member 521, and the combination plate 52 is combined with the turntable 51 through the outer frame 523, but the present disclosure is not limited thereto. The shape of the outer frame 523 is, for example, a square, and each side edge of the outer frame 523 has a convex plate 5231 protruding towards the outer side of the outer frame 523. The convex plates 5231 are configured to engage with the respective convex block 5122. The shape of the outer frame 523 is not limited in the present disclosure. The aforementioned positioning holes 522 are, for example, the four positioning holes 522 located at the four corners of the square outer frame 523, but are not limited thereto. The quantity or position of the positioning holes 522 can be changed as needed. The four connecting arms 525 extend, for example, radially from the center of the combination plate 52 towards the outer frame 523 to present a radial structure. In this embodiment, the connecting arms 525 directly form the elastic member 521 of the combination plate 52, but are not limited thereto.

The first combination unit 5211 in this embodiment protrudes for example, from the elastic member 521 towards the assembly member 53, but is not limited thereto. In addition, in terms of shape, the first combination unit 5211 in this embodiment is a cylindrical structure with a chamfer or a convex block with a chamfer. However, the first combination unit 5211 in other embodiments can be a semi-circular convex point, but the present disclosure is not limited thereto. Correspondingly, the second combination unit 5311 in this embodiment is, for example, a hole portion formed on the contact plate 531. The aforementioned hole portion can be a through hole or a blind hole. In addition, in some embodiments, the shape of the first combination unit 5211 and the shape of the second combination unit 5311 can be swapped, and the details can be set according to requirements.

Please refer to FIGS. 4A and 4B. In this implementation, there is a segment difference generated by bending between the connecting arms 525 and the outer frame 523. Thus, when the combination plate 52 is connected to the turntable 51, a gap 527 (see FIGS. 3B and 3C) can be formed between the surface of the connecting arms 525 close to the turntable 51 and the surface of the turntable 51 close to the connecting arms 525, but the present disclosure is not limited thereto. The gap 527 can accommodate the deformed elastic member 521 when the elastic member 521 is deformed, thereby avoiding the interference of the turntable 51 with the deformation of the elastic member 521.

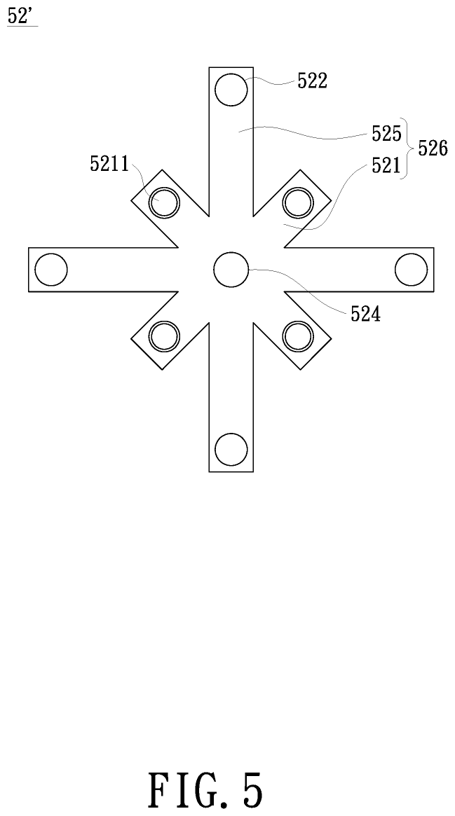

FIG. 5 is a schematic top diagram of a combination plate in another embodiment of the present disclosure. Please refer to FIG. 5. The combination plate 52′ in this embodiment may not include an outer frame 523. The combination plate 52′ may have eight cantilevers 526 extending from the center of the combination plate 52′ in the radial direction of the axis A (not shown in the figure, please refer to the center of the first central hole 524), but the quantity of the cantilevers 526 is not limited in the present disclosure. Each one of some cantilevers 526 is provided with a positioning hole 522 and thereby being suitable for serving as the connecting arms 525 for fixing the turntable 51, while each one of the other cantilevers 526 is suitable for serving as the elastic member 521. In other words, the elastic member 521 in this embodiment is also a radial structure. In addition, in this embodiment, the distance between the positioning hole 522 on the connecting arm 525 and the axis A (the first central hole 524) is greater than the distance between the first combination unit 5211 on the elastic member 521 and the axis A (the first central hole 524).

Because the thickness of the elastic member 521 or the quantity of the radial-shaped cantilevers 526 can affect the elasticity of the elastic member 521, therefore, the quantity and shape of the elastic members 521 can be set according to demand, and correspondingly the quantities of the first combination units 5211 and the second combination units 5311 can be changed.

Please refer to FIGS. 2A to 4B. The combination plate 52 and the assembly member 53 in this embodiment are rotatably connected to each other through a connection member 54. The connection member 54 is, for example, a screw, but not limited thereto. The connection member 54 includes a rod portion 541 and a cover portion 542. The cover portion 542 is connected to a first end of the rod portion 541, while a second end of the rod portion 541 is movably embedded in the first central hole 524 of the combination plate 52 and connected to the second central hole 533 of the contact plate 531. The first end and the second end of the rod portion 541 are opposite to each other. The central axis of the rod portion 541 overlaps with the axis A. Through this structure, the rod portion 541 is adapted to serve as the rotation axis of the combination plate 52 when the combination plate 52 is connected to the assembly member 53.

The rod portion 541 and the second central hole 533 can be screwed to each other through the threads arranged on the rod portion 541, or clamped to each other through the size difference between the rod portion 541 and the second central hole 533 and the material elasticity, for example.

The connection member 54 pushes against the combination plate 52 through the cover portion 542 so that the combination plate 52 continuously contacts the assembly member 53. As shown in FIG. 4B, when the first combination unit 5211 is separated from the second combination unit 5311, at least a portion of the combination plate 52 (near the first central hole 524) remains in contact with at least a portion of the assembly member 53 (near the second central hole 533).

Please refer to FIGS. 2A to 4B. The screw rod 532 of the assembly member 53 in this embodiment has a connecting portion 532a, a neck portion 532b, and a threaded portion 532c. A first end of the connecting portion 532a is connected to the first surface 531a of the contact plate 531, a second end of the connecting portion 532a is connected to a first end of the neck portion 532b, and a second end of the neck portion 532b is connected to the threaded portion 532c. The first end and the second end of the connecting portion 532a are opposite to each other, and the first end and the second end of the neck portion 532b are also opposite to each other. The surfaces of the connecting portion 532a and the neck portion 532b, for example, have no threads, while the threaded portion 532c is provided with threads adapted to screw to the first component 31. As shown in the figure, the radius of the neck portion 532b is different from the radius of the connecting portion 532a and the threaded portion 532c, for example, the radius of the neck portion 532b is greater than the radius of the connecting portion 532a and the threaded portion 532c. Thus, the neck portion 532b is adapted for being limited by the first component 31 or by the component connected to the first component 31, but not limited thereto.

As shown in FIGS. 2A and 2B, in terms of the detailed limiting method, the first component 31 in this embodiment has a limiting member 31a, which is adapted to push against the neck portion 532b in the extension direction of the axis A, thereby allowing the assembly member 53 to be rotatably limited to the first component 31 through the neck portion 532b. In this embodiment, the limiting member 31a includes a groove body 311, a sheet body 312 that can be assembled to and disassembled from the groove body 311, and a stopper block 313, but is not limited thereto. The groove body 311 is, for example, provided with a through-hole 311a at the bottom thereof, and the diameter of the through-hole 311a is smaller than the diameter of the neck portion 532b but larger than the diameter of the threaded portion 532c. The sheet body 312 is, for example, L-shaped. A portion of the sheet body 312 covers the groove body 311 in the direction D1 when the sheet body 312 is combined with the groove body 311. In addition, the portion of the sheet body 312 covering the groove body 311 further has a notch 312a. The notch 312a is adapted to allow the connecting portion 532a to pass therethrough. The stopper block 313 has, for example, a groove 313a and therefore is U-shaped.

When combined, the neck portion 532b can be rotatably arranged in the groove body 311, the disc surface of the neck portion 532b pushes against the bottom of the groove body 311, and the threaded portion 532c is arranged to pass through the through-hole 311a. The sheet body 312 is clamped to the connecting portion 532a through the notch 312a, while the stopper block 313 is clamped to the connecting portion 532a and located between the sheet body 312 and the groove body 311. In addition, when combined, the opening direction of the groove 313a of the stopper block 313 is opposite to the opening direction of the notch 312a of the sheet body 312. By the above structure, when the screw rod 532 moves in the direction D1 under force, one surface of the neck portion 532b is blocked by the groove body 311 and cannot pass through the through-hole 311a and the other surface of the neck portion 532b is blocked by the stopper block 313, which makes the screw rod 532 rotatably limited to the first component 31. However, the combination method between the adjustment device 5 and the first component 31 is not limited by this. For example, in one embodiment, the stopper block 313 may not be provided when the neck portion 532b has a longer structure in the direction D1. Other methods of fixing the neck portion 532b to the first component 31 can refer to the conventional structure for rotatably fixing one object to another object.

From the above description, it is known that the projection lens module and the projection device with this projection lens module in the embodiment of the present disclosure have an adjustment device that can drive the movement of the projection lens. Because the adjustment device has a contact plate and an assembly member, the adjustment device can adjust the position of the projection lens indirectly connected to the screw rod through the turntable when the second combination unit on the assembly member and the first combination unit on the contact plate are engaged with each other while the screw rod of the assembly member can still rotate. When the screw rod of the assembly member is fixed, the elastic deformation of the elastic member caused by the push between the first combination unit of the contact plate and the second combination unit of the assembly member separates the first combination unit from the second combination unit, and therefore the adjustment device cannot adjust the position of the projection lens indirectly connected to the screw rod through the turntable. Therefore, when the projection lens is driven to the limit position of the adjustable range by the adjustment device, the adjustment device will automatically disconnect to prevent excessive movement of the projection lens.

The foregoing description of the preferred embodiment of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the invention”, “the disclosure” or the like is not necessary limited the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the disclosure as defined by the following claims. Moreover, no element and component in the disclosure is intended to be dedicated to the public regardless of whether the element or component is explicitly recited in the following claims.

What is claimed is:

1. A projection lens module, comprising:
a projection lens, configured to project an image beam; and
an adjustment device, connected to the projection lens and configured to adjust a movement of the projection lens, and the adjustment device comprising:
a turntable, configured to rotate around an axis;
a combination plate, fixed to the turntable and having an elastic member, wherein the elastic member has at least one first combination unit; and
an assembly member, comprising a contact plate and a screw rod, wherein the contact plate has a first surface and a second surface opposite to the first surface, the screw rod connects the first surface of the contact plate, the second surface of the contact plate has at least one second combination unit, and the at least one second combination unit is clamped to the at least one respective first combination unit;
wherein when the turntable rotates, the at least one first combination unit of the combination plate is configured to drive the at least one respective second combination unit of the assembly member to rotate around the axis, wherein when the turntable maintains rotation and the assembly member is fixed, the elastic member is configured to generate elastic deformation by pushing between the at least one first combination unit and the at least one second combination unit, and therefore the at least one first combination unit and the at least one second combination unit are separated from each other so that the combination plate and the assembly member rotate relatively.

2. The projection lens module according to claim 1, wherein the adjustment device further comprises a connection member, the connection member comprises a rod portion and a cover portion, the cover portion is connected to a first end of the rod portion, a second end of the rod portion is movably embedded in a first central hole of the elastic member and a second central hole of the contact plate, so that the combination plate is connected to the assembly member, and a central axis of the rod portion overlaps with the axis, wherein the first end of the rod portion and the second end of the rod portion are opposite to each other.

3. The projection lens module according to claim 1, further comprising a first component, wherein the first component is connected to the projection lens, the adjustment device is rotatably arranged on the first component, the screw rod has a connecting portion, a neck portion, and a threaded portion, a first end of the connecting portion is connected to the first surface of the contact plate, a first end of the neck portion is connected to a second end of the connecting portion, one end of the threaded portion is connected to a second end of the neck portion, and the assembly member is rotatably limited to the first component through the neck portion.

4. The projection lens module according to claim 3, wherein a diameter of the neck portion is greater than a diameter of the threaded portion, the connecting portion accommodates a limiting member of the first component, and the limiting member pushes against the neck portion in an extension direction of the axis so that the assembly member is rotatably limited to the first component.

5. The projection lens module according to claim 3, further comprising a second component, wherein the threaded portion is screwed to an adjustment member of the first component, the first component is connected to the second component, and the adjustment member drives the second component to have a displacement when the threaded portion rotates.

6. The projection lens module according to claim 1, wherein the elastic member is a radial structure.

7. The projection lens module according to claim 6, wherein the combination plate further has an outer frame, the outer frame surrounds the elastic member, and the combination plate is combined with the turntable through the outer frame.

8. The projection lens module according to claim 7, wherein a surface of the turntable facing the combination plate has a plurality of positioning columns, the outer frame of the combination plate has a plurality of positioning holes, and the plurality of positioning columns are fixed to the plurality of positioning holes respectively.

9. The projection lens module according to claim 7, further comprising a plurality of screw members, wherein the outer frame of the combination plate has a plurality of positioning columns, and the plurality of screw members are arranged to pass through the plurality of respective positioning holes to screw to the turntable.

10. The projection lens module according to claim 1, wherein the combination plate has a plurality of cantilevers extending in a radial direction of the axis from a center of the combination plate, a part of the plurality of cantilevers is suitable for serving as connecting arms for fixing the turntable, and another part of the plurality of cantilevers is suitable for serving as the elastic member.

11. The projection lens module according to claim 1, wherein the at least one first combination unit protrudes from the elastic member towards the assembly member, and the at least one second combination unit is a hole portion.

12. A projection device, comprising:
a light source, configured to provide an illumination beam;
a light valve, configured to convert the illumination beam into an image beam; and
a projection lens module, comprising:
a projection lens, configured to project the image beam; and
an adjustment device, connected to the projection lens and configured to adjust a movement of the projection lens, and the adjustment device comprising:
a turntable, configured to rotate around an axis;
a combination plate, fixed to the turntable and having an elastic member, wherein the elastic member has at least one first combination unit; and
an assembly member, comprising a contact plate and a screw rod, wherein the contact plate has a first surface and a second surface opposite to the first surface, the screw rod connects the first surface of the contact plate, the second surface of the contact plate has at least one second combination unit, and the at least one second combination unit is clamped to the at least one respective first combination unit;
wherein when the turntable rotates, the at least one first combination unit of the combination plate is configured to drive the at least one respective second combination unit of the assembly member to rotate around the axis, wherein when the turntable maintains rotation and the assembly member is fixed, the elastic member is configured to generate elastic deformation by pushing between the at least one first combination unit and the at least one second combination unit, and therefore the at least one first combination unit and the at least one second combination unit are separated from each other so that the combination plate and the assembly member rotate relatively.
